(19) United States
(12) Patent Application Publication
(10) Pub. No.: US 2009/0090537 A1
(43) Pub. Date: Apr. 9, 2009

(54) Aesthetic and Safe Electrical Extension Cord to Floors

(76) Inventor: Vinicius Jose Gomes Nunes, Sao Paulo (BR)

Correspondence Address: Vinicius Jose Gomes Nunes, 386 Juvenal Galeno St., Sao Paulo, 04290-030, BR

(21) Appl. No.: 12/051,499

(22) Filed: Mar. 19, 2008

(30) Foreign Application Priority Data
Mar. 20, 2007 (BR) 8700403 U

(51) Int. Cl. H01B 7/00

(52) U.S. Cl. 174/135

(57) ABSTRACT

An electrical extension cords that has a format that prevents slips from who passes upon it and is able to adhere in diverse kinds of floor, smooth or upholstered, through a set of suction cups and Velcro tapes, avoiding to disturb the circulation of people where it is installed. Composed for a flexible body (1) that has in its interior wires of conduction (2) and in its inferior surface suction cups (5) and Velcro tapes (6). In its extremities there are a plug (7) and one or more outlets (8). It can be conveniently kept in rolls (9) when it is not in use.

### CROSS-REFERENCE TO RELATED APPLICATIONS

This application claims the benefit of the Brazilian patent MU8700403-8, filed 2007 Mar. 20 by the present inventor.

### FEDERALLY SPONSORED RESEARCH

Not Applicable

### SEQUENCE LISTING OF PROGRAM

Not Applicable

### BACKGROUND OF THE INVENTION

1. Field of Invention

This invention generally relates to electrical extension cords, specifically to a cord which are fixed on the floor by suction cups or Velcro.

2. Prior Art

Innumerable electrical extension cords already are known, useful when it is necessary to turn a device on in a place where there isn't an outlet near. However, the existing cords show the inconvenience that the wire stays free on the floor, making the people when passing for it stumble and suffer accidents, or pull it, removing the plug from the outlet and causing the disconnection of the equipment in use.

An action too much common consists in use adhesive tape to immobilize the wire on the ground. However, the use of these tapes lets marks, beyond to be esthetically condemnable. The use of adhesives or glues directly in the wire, as described and requested in the Brazilian patents MU7301709-4 (1993) and PI9204252-0 (1992), let residues impregnated on the ground, being these difficult to be removed, beyond the fact that the adherence power of the glue reduces with the time, being able the wire to free itself. The use of nails, screws or cramps to fix the electric wires damages the floor.

### OBJECTS AND ADVANTAGES

Having in mind these problems with the current cords and in the intention to solve them, the aesthetic and safe electrical extension cord to floors, object of the present patent, uses suction cups and Velcro to fix the wire and has a format that adjusts in the floor.

To smooth floors, the contact and adherence are kept for the suction cups. By suction, the cord naturally adheres on the ground. When stepped on, its adherence increases, instead of to be moved from its original position. In the case of floor with carpet or similar, the Velcro tapes in the base of the extension keep the adherence.

Thus, it can be used in every kind of floors found in stores, markets, industries and houses: floors in wood, ceramics, granite, marble, vinyl, rubberized, carpets, upholstered, and so on.

### SUMMARY

In accordance with the invention, the extension comprises a body with a shape that does a curve on the floor where the wires pass, while the suction cups and the Velcro stay in contact with the ground.

### DRAWINGS

### Figures

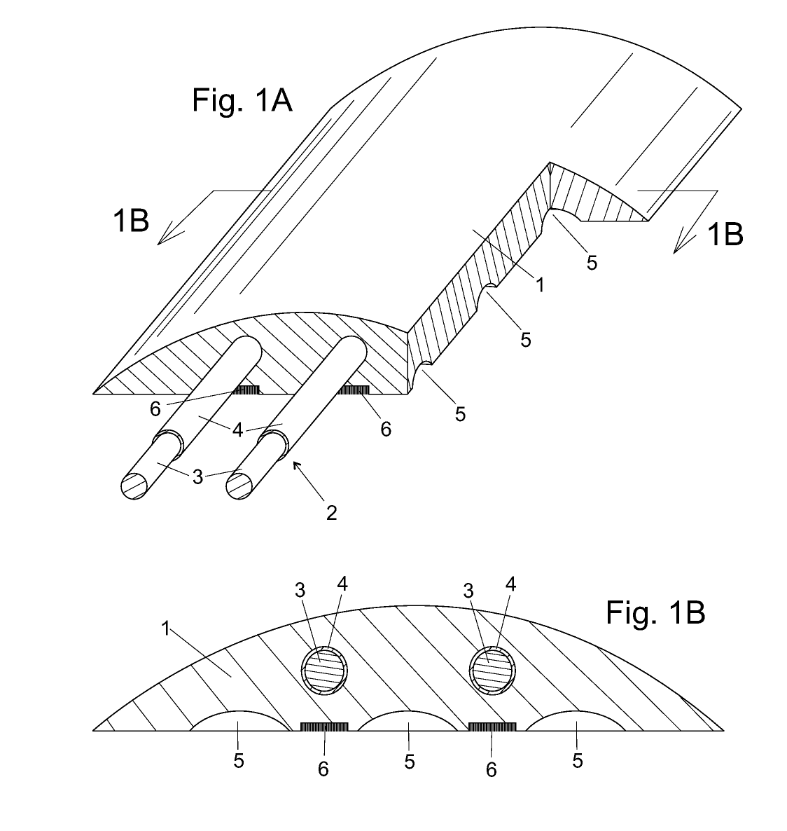

FIGS. 1A and 1B is a perspective view of the body of the cord and a view of the transversal section indicated in the FIG. 1A.

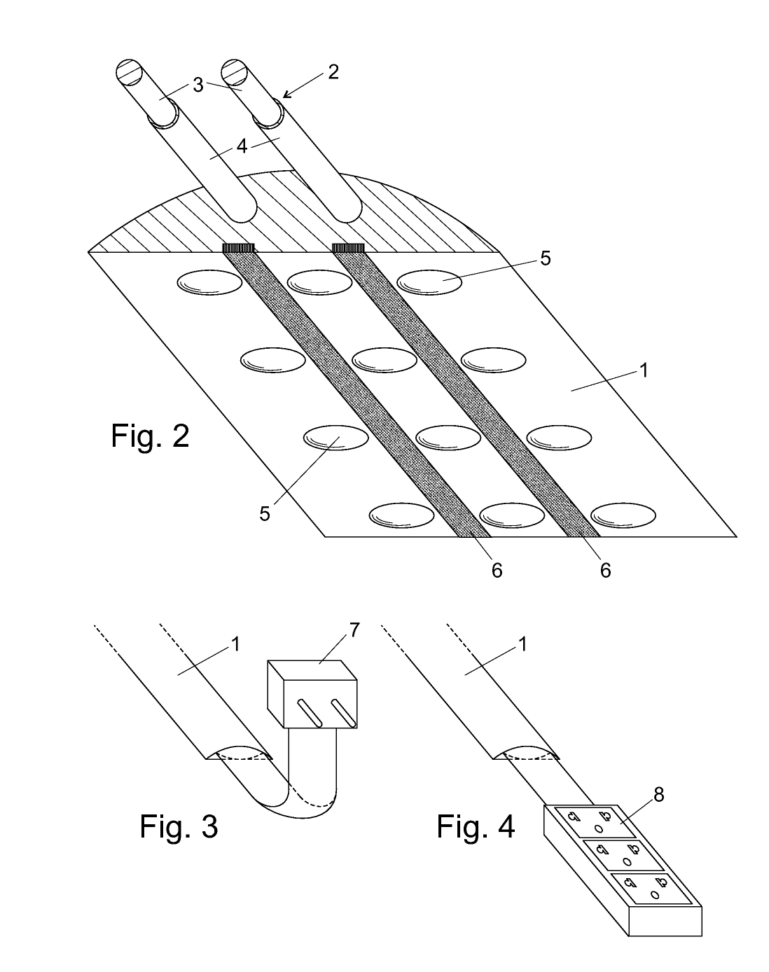

FIG. 2 is a perspective inferior view of the cord, showing the suction cups and the straps of Velcro.

FIG. 3 is a perspective view of one of the extremities of the cord, highlighting the plug.

FIG. 4 is a perspective view of the other extremity of the cord, highlighting the outlet.

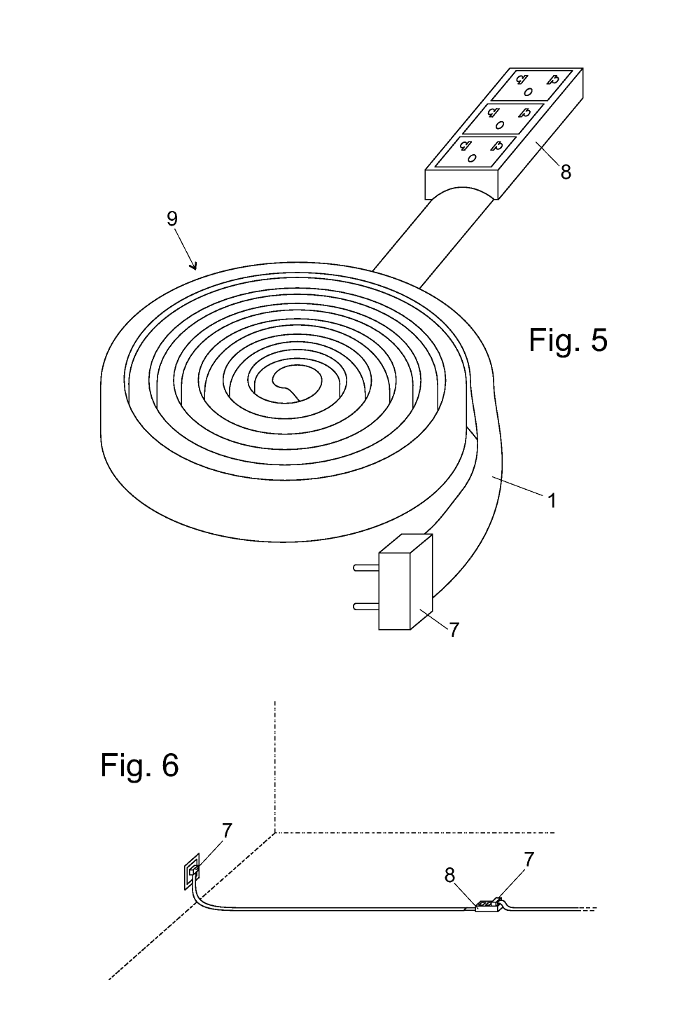

FIG. 5 is a view of the cord when it will not be in use, properly rolled.

FIG. 6 is a view of the cord when in use, showing two extensions in series with a plug connected in the outlet of a wall.

### REFERENCE NUMERALS

| | |
|---|---|
| 1 | body |
| 2 | wires |
| 3 | conductor material |
| 4 | insulator material |
| 5 | suction cups |
| 6 | Velcro tapes |
| 7 | plug |
| 8 | outlet |
| 9 | cord rolled |

### DETAILED DESCRIPTION

### FIGS. 1-4—Preferred Embodiment

In accord with the figures above enumerated, we see that the aesthetic and safe electrical extension cord to floors consists of a body 1, that contains in its interior wires of conduction 2, these composites for conducting material 3 and a isolating layer 4, placed parallel to the direction of the cord and keeping distance between themselves. The body 1 can be made in diverse materials, as plastic and rubber, in function of required flexibility and resistance for each application.

The inferior face of body 1, that it will be in contact with the floor, has suction cups 5, that adhere for suction in the smooth floors, and straps of Velcro 6, that adhere to the upholstered floors.

The straps of Velcro 6 are placed in a space of the inferior surface so that the straps don't separate the body 1 from the ground.

There is in one of the extremities of the extension a plug 7, to be connected to the electricity network, and in other extremity one or more outlets 8, where the equipment will be energized. The plug 7 and outlet 8 have a format and size so that they keep the same characteristics of security and esthetic of the set.

### Operation—FIGS. 5 and 6

When the cord will not be in use, it is appropriate that it stays rolled up, as well as is shown in roll 9. Thus, it can be easily kept and transported.

To achieve larger lengths, some extensions can be associates in series without compromising the security or the discretion of the set.

### CONCLUSION, RAMIFICATIONS, AND SCOPE

Accordingly, the reader will see that the aesthetic and safe electrical extension cord to floors is presented like an efficient way of carrying electricity to an equipment without to compromise the security of someone that passes for it and keeping the harmony of the place. It can be used in various situations and in the almost every kind of floor.

While the above description contains many specificities, these should not be construed as limitations on the scope of the invention, but as exemplifications of the presently preferred embodiments thereof. Many other ramifications and variations are possible within the teachings of the invention. For example, more than two wires could pass in the body, like an additional wire that can be used for the ground connection; the extension could have just the suction cups or just the Velcro tapes, case the user has only a kind of floor; the conductor inside the body could be constitute for many thin wires, increasing the flexibility.

Thus the scope of the invention should be determined by the appended claims and their legal equivalents, and not by the examples given.

I claim:

1. A aesthetic and safe electrical extension cord to floors comprising a body with a adequate format, having in its interior conduction wires where the electric energy will be carried and being able to fix on the floor through suction cups and Velcro straps.

2. The aesthetic and safe electrical extension cord to floors of claim 1 wherein said the format of the body, at same time, prevents slips for who steps on and also keeps discretion and suavity.

3. The aesthetic and safe electrical extension cord to floors of claim 1 wherein said body has in its surface in contact with the ground suction cups that fix the cord when the floor is smooth.

4. The aesthetic and safe electrical extension cord to floors of claim 1 wherein said body has in its surface in contact with the ground Velcro straps that fix the cord when the floor is carpeted.

5. The aesthetic and safe electrical extension cord to floors of claim 1 wherein said body is composed of a flexible material so that can be rolled easily, make easier to keep and transport it.
